(19) United States
(12) Patent Application Publication
(10) Pub. No.: US 2005/0162979 A1
(43) Pub. Date: Jul. 28, 2005

(54) Blister label

(76) Inventors: John Kvist Ostergaard, Nibe (DK); Christian F. Fischlein, Holstebro (DK); Carsten Bitsch Pedersen, Struer (DK)

Correspondence Address: James C Wray, 1493 Chain Bridge Road, Suite 300, McLean, VA, 22101, US

(21) Appl. No.: 10/519,301

(22) PCT Filed: Jun. 26, 2003
(86) PCT No.: PCT/DK03/00440

(30) Foreign Application Priority Data
Jun. 27, 2002 (DK) PA200201003

(51) Int. Cl. G04B 47/00

(52) U.S. Cl. 368/10

(57) ABSTRACT

The present invention relates to a packaging blister foil with a blister label for use in a packaging blister foil with a blister label, a device for storing and registering the dispensing of drug doses, where said drugs are packed in packaging blister foil with a blister label of the blister type, as well as a method for registering the dispensing of a drug dose.

### BACKGROUND OF THE INVENTION

The present invention relates to a blister label for use in a packaging blister foil with a blister label, a device for storing and registering the dispensing of drug doses, where said drugs are packed in packaging blister foils with a blister label of the blister type, as well as a method for registering the dispensing of a drug dose.

Most drugs are designed to be dispensed and taken at certain intervals in time, in order to get the optimum effect of the drug, as the drug was designed to from the manufacturer side. In other circumstances, especially when testing a new drug, it is important for the drug manufacturer to be able to design a programme, where the dispensing of drugs is predefined at certain intervals depending on the active drug contained in the drug test, as well as registering when this event actually took place.

Especially when carrying out clinical tests for new drugs as pant of the testing cycle requested by authorities before introducing a new drug to the public it is vital for the manufacturer to know exactly how this drug will affect the patient. When testing drugs on humans or animals there is a number of uncertain factors, which can influence the effectiveness of the drug on the test person or animal.

The disease, which it is desired to cure or treat, can be in a more or less advanced state in the patient, whereby the drug will have a varying effect according to how advanced the disease is, the size of the patient, the metabolism of the patient, the regular diet of the patient, etc. and etc. All these aspects can be observed and judged by experienced doctors, whereby the effectiveness of the drug in typical scenarios can be determined.

Another factor, which also can influence the effectiveness of a drug in test is the timing with which the drug is taken by the patient. If variations in the period between each drug dose occur the effectiveness of a drug can be minimum, or if drugs doses are taken with too short a time span drugs side effects can be more serious than what would have occurred had the drugs been taken at regular intervals.

Especially during clinical tests the compliance that is the difference in time when a drug is supposed to be taken and when it is actually taken, is of great importance in that the more uncertain factors that can be eliminated from a test programme the more reliable one can judge the test programme.

The trend in drug making is to use less and less active drugs in each dose, whereby the risk of side effects becomes less and less. This, however, requires that the drugs are taken at regular intervals in order to determine whether or not the drug has an effect.

A clinical test usually lasts eighteen months, but the entire test programme for introducing a new drug usually lasts six years or more in order to get the authorities' approval. During the early clinical tests a number of patients suffering from the disease, for which the drug is developed to have an effect, are selected. Each patient enrolling in a test programme is then required to keep a diary and follow the time schedules set up by the drug testing company. The patient diary is usually in the shape of a number of pages, and each page has two or three carbon copies. In the diary the patient will note his or her general condition, the time when the drug was taken, as well as any extraordinary circumstances, which can be of importance for judging the result of the clinical test. Two copies are thereafter sent to secretaries, who will separately type in the data from the patients. The entered data will be compared and corrected if there is a deviance between the two sets of identical data, whereafter the data will be forwarded to the company carrying out the test. In this way it is possible for the company to get a large number of test results, which have been correlated and corrected at the source.

There is, however, as described above, a number of weaknesses in this system, which can jeopardize a clinical test programme.

Patients having volunteered to enrol in test programmes has an obligation to carry out the test according to the schedule set out by the testing company. Should, however, a patient fail to take a drug dose at the required time for one reason or another, this should of course be noted in the diary. This causes two undesired effects: first it will be difficult for the drug manufacturer to judge the effect of the medication during that interval, where there was an irregular taking of doses, and furthermore in some cases the patient will due to the obligation of the pre-programmed scheduler drug taking perhaps not fill in the correct time in the diary.

From U.S. Pat. No. 4,526,474 a system is known where drug doses in pill, tablet or capsule form are packaged in a blister pack, where electrical connections are provided such that when said blister pack is arranged in an electronic timer system it can give off a signal to the user when the next dose is to be administered. When an electrical connection is broken, it starts a timer which after a predetermined period of time initiates an alarm signalling to the user that he or she should dispense and take the following dose. Apart from the fact that this system is only concerned with notifying the user of when a drug dose is to be taken, the construction of the blister pack itself comprises a number of drawback which may be detrimental to the use of said blister pack.

The blisters containing the drug doses arranged on the blister pack are provided with electrical connection means such that the electrical connection means across each blister are arranged in series. With this arrangement two electrical leads are necessary for each blister, which apart from taking up a rather large space on the blister label also, due to the size of customary blister labels, makes it difficult and thereby expensive to arrange the electrical leads in a reliable manner on the blister label. Furthermore, the system does not provide a back-up redundancy such that if by mistake during packaging, handling or otherwise, the electrical leads are damaged, the device will register the disconnected electrical lead at the same level as if a drug dose was dispensed.

Furthermore, the system described above does not suggest that the system can be used for collecting data relating to when an electrical lead across a blister was broken or provide the possibility for interaction with the device in order to either alter the cycle with which the drug doses shall be dispensed or other interactive functions.

### OBJECTS AND SUMMARY OF THE INVENTION

It is therefore an object of the present invention to provide a device for storing and registering the dispensing of drug doses. Furthermore the device comprises means for reminding the patient of when a certain drug dose has to be taken, both as a visual signal and/or as an audible signal.

The drugs are advantageously stored in a packaging blister foil with a blister label of the blister type. Such a packaging blister foil with a blister label is made from a first, often flexible, foil, often transparent, wherein a number of depressions corresponding to the number of drug doses stored in the packaging blister foil with a blister label is formed. The depressions in the flexible foil are thereafter closed by adhesively applying a blister label to the side of the foil from which the depressions are formed.

It is also an object of the present invention to provide a blister label for use in a packaging blister foil with a blister label facilitating packaging of drugs in tablet or pill form, wherein electrical connections built into the label will signal to the device when a connection is broken as a consequence of a drug being dispensed, whereby it will be possible to register the time when the lead was broken and thereby when the drug was dispensed. It is in this connection of course an assumption that once a drug is dispensed it will also be taken by the patient at that time. However, as most patients are voluntarily enrolling in these test programmes and are interested in being treated for a disease it is assumed that once they remember to dispense the drug it will be taken.

Furthermore, the invention also has the object of providing a method, where a packaging blister foil with a blister label is placed in a device, whereby the method provides for registering the dispensing of a drug dose, where the dose is in tablet, pill, or the like form, and is packaged in a packaging blister foil with a blister label.

These objects are achieved by a device for storing and registering the dispensing of drug doses, wherein said device comprises contact points, at least corresponding to contact islands provided on the label as well as holding means for holding said contact islands of the packaging blister foil with a blister label in electrical contact with the contact points, and that said contact points are connected to a computing means comprising an electrical timer system, output means in the form of a display and optionally an audible alarm data storing means and a source of energy.

By this arrangement it is assured that a firm electrical contact is established between the device and the packaging blister foil with a blister label. By measuring the electrical contact and the conductivity between two contact points it can be determined whether or not there is connection. In case there is a connection the drug in the packaging blister foils with a blister label has not been forced through the blister packaging and thereby breading the electrical connection and consequently the drug has not been dispensed. However, if there is no contact, it indicates that the drug has been dispensed. In this case the computing means will register the time from the electronic timer system and store this information in the data storage means. Also at the same time, i.e. the time when the break of the connection occurred will set a timer running indicating how much time has elapsed since that last break. The user will then know, how long it was since the last dose was taken, and therefore be able to calculate when the next dose is to be taken.

In a further advantageous embodiment the holding means in the device comprises a first lockable member, which member can be brought from an open position in which a packaging blister foil with a blister label can be placed in the device to a closed position, where the member fixates the packaging blister foil with a blister label in relation to the device. This is particularly important in that it hereby is possible to fixate the contact points in contact with corresponding contact islands on the packaging blister foil with a blister label to ensure a firm and electrically conductive connection between the device and the packaging blister foil with a blister label. By having this secure and conductive contact between these two members it is possible to register whether or not a drug dose has been dispensed and when this was dispensed.

The lockable member is so firmly anchored in the device that it will be difficult for the patient to accidentally remove the packaging blister foil with a blister label from the device. Hereby is eliminated the risk of accidentally removing and/or replacing the packaging blister foil with a blister label, e.g. with a different packaging blister foil with a blister label or turning the packaging blister foil with a blister label round, such that the computing means as well as the storage will collect and treat wrong or faulty data. The lockable member can engage a switch provided in the device, such that an active indicator is provided for indicating that the packaging blister foil with a blister label as well as the lockable member is correctly engaged.

In a further advantageous embodiment of the device means for inducing a current via the contact islands of a blister label and thereby across the electrical connection means is provided, and that said means further comprises a shunt resistor, and optionally a signal amplifier and an analogue/digital converter, such that the output for further processing is digital. By providing electronic circuitry such that the output is digital, the further processing of the input is substantially simplified.

By providing computing means in the device it is possible to generate output to the display indicating in the display simultaneously or by manipulating switches provided on the device, the time elapse from last drug dispensing, real time, error messages, low energy level indicators, etc. According to the size of the display all data can be shown or only selected data, which can be called up in the display by manipulating switch devices provided on the device.

In addition to the indications on the display further visual and/or audible indicator/alarm can be provided on the device, whereby it will visually be possible for the user to see that the time has come for dispensing and taking the following drug dose. This visible indicator can for example be in the shape of a light diode. A audible alarm is also desirable in that it can be arranged to require an active input from the user in order to switch the alarm off, whereby the user has become aware of now is the time to take the drug and has handled the drug dispensing device in order to switch the alarm off.

In order to download the data from the device to an outside device an interface in the shape of a mobile flash card, USB gate, infrared transmission, parallel or serial port may be provided, such that communicating/transferring data to and from an outside device is achievable.

By providing the device with a modem it is possible for the doctor involved in the clinical test and/or for the company directly to call up the device and download the data stored in the memory bank in the device without the test person/user having to bring the device to the doctor or the drug manufacturer.

By using a USB gate, which is currently the most easy to use connection between two devices, the doctor can easily download data from the device to his PC for further computing and sending out to the manufacturer.

In a similar manner it is possible to use infrared transmission means built into the device, whereby upon activation of this communicating device data will be transferred from the device to for example a PC.

In a further embodiment the device can be equipped with a wireless communication system such as for example Blue Tooth, whereby it will be possible to send and receive data from the device without having any physical hook-up. Especially in treatment environments such as hospital, clinics and the like, the Blue Tooth technology can advantageously be incorporated in the communication system built into the device.

Data can of course also be transferred by the traditional means in the shape of a parallel or serial port and by a common cable means as used for connecting hardware devices in a computer network.

The data store facility inside the device can have a size whereby it is possible to save all data for the entire test period in the data storage, such that only copies of this data are send off to the outside agency, e.g. doctor or manufacturer. Should any mishap or corruption of data therefore occur it is possible to download a new version from the device itself, which will keep the original data in a backup storage. By providing the device with a mobile flash card, data storage and data transfer can be improved.

By providing computing means and interface means in the device it is possible to reprogram the device. The computing means is originally programmed with the sequence of when the drug should be dispensed, and/or other information/data relating to the drug, drug batch, user, doctor, etc. If it is desirable to use the device in connection with other types of drugs or with different types of drug doses the sequence of dispensing can be reprogrammed via the interface means.

In a further advantageous embodiment the computer comprises data relating to any one or a combination of the following: drug user, drug type, drug identification, drug manufacturer, sequence of dispensing each dose, prescribing doctor or hospital. When comparing the information stored on the packaging blister foil with a blister label with the information stored in the computer about the user it is possible to assure that the correct user has been issued with the correct drug.

Furthermore, the sequence of dispensing the dose can vary from patient to patient according to the test programme, and it is therefore important that in some instances the correct user receives the correct batch of drugs with the special sequence of dispensing the drugs. In case there is a mismatch between the data stored on the packaging blister foil with a blister label and the data stored in the computing means an error message is generated. This error message can for example be in the shape of an indicating sign blinking in the display, and audible alarm, and/or a signal being sent off to the doctor that some error has occurred.

The invention further relates to a blister label for use in a packaging blister foil with a blister label facilitating packaging of drugs in tablet capsule and pill form, which blister label is special in that said label is rupturable, at least in zones corresponding to the blisters, and that for each drug dose there is provided an electrical connection means having a certain resistance value where said means is extending across each rupturable zone such that when the label is ruptured the electrical connection means will break, and that each electrical connection means is connected in either end to a first and second lead in parallel electrical connection, and that at least two contact islands are provided at terminal ends of the first and second lead, adjacent an edge of the blister label.

This construction gives a number of advantages in comparison to the prior art. By having rupturable zones at least in zones corresponding to the blisters a very well defined break zone is achieved. The blisters shall of course correspond to the size of the drugs meaning that if the drug is triangular or elongated the blister will have a corresponding shape or at least a shape being able to accommodate the drug completely inside said blister. The defined break zone also assures that a break of the electrical connection means will occur in correspondence to the squeezing out of the drug kept in the blister. Furthermore, it can be avoided as these well defined rupturable zones are provided that the squeezing out of a drug in the blister packaging will cause other drugs to be squeezed other out than the one the user desires to take out. To further assure that the desired drug dose and no other drug doses are squeezed out the device for storing the registering and dispensing of drug doses can be designed such that the blister is placed on a tray, wherein apertures are provided corresponding to each blister. This means that the blister packaging is supported except in the areas with rupturable zones corresponding to drugs being present on the blister.

The arrangement of electrical connection means extending across each rupturable zone, where said electrical connection means are arranged in parallel by means of two electrical leads provides a very simple and yet fool-proof way of detecting, if and when a drug dose has been dispensed, whereby the electrical connection means are broken. The leads and the electrical connection means together constitute a collective resister, giving the system a certain value. When an electrical connection means is broken due to the squeezing out of a drug dose, the resistance value of the entire system will change and thereby give rise to a change, which it is possible to detect between the two contact islands.

When a blister label containing such an arrangement is placed in a device for dispensing drug doses as described above, a current is applied to the electrical leads and connection means arranged on the blister label. Hereby a system in equilibration is detected in that the resistance value is substantially constant. When a drug dose is squeezed out, a change in the applied current will be detected and via the electronic circuitry in the device, it will be transformed into a digital signal for further processing as described above.

In a further advantageous embodiment a second set of contact islands is provided in the opposite end of the first contact islands of said first and second leads, whereby a redundancy measurement may be conducted. In this way a simple back-up system is provided, such that if a bad contact or the like is present, the redundancy system will provide the back-up information, i.e. causes a change in the current, whereby a signal will be generated in the dispensing device.

In order to give more stable and conclusive input, i.e. changes in the current situation on the blister label, a reference resistor may, in a further advantageous embodiment, be integral with one of the first or second leads. By appropriately dimensioning the integrated resistor, the power consumption may be optimized and at the same time the reliability of the signal obtained via the system may be improved.

Furthermore, by arranging a reference resistor on the blister label possible variations in the resistor values in the electrical leads can be eliminated as the reference resistor will be manufactured with the same variations as the leads, whereby, due to the evening out process in the dispensing device's computing means, reliable indications free from interference will be registered.

In a still further advantageous embodiment the second set of electrical connection means corresponding to a second row of drug doses arranged on said blister label is provided, and that said second set of electrical connection means are connected in parallel in a fist end of said connection means to the first or second lead and in a second end of said electrical connection means to a third lead, and that said third lead is provided with at least a contact island adjacent the contact islands of the first and second leads, adjacent an edge of the blister label.

With this embodiment a blister label containing three leads, such that an advantageously centrally arranged lead is shared between two sets of electrical connection means transverse blister pockets on either side of the centrally arranged common lead is provided. This is especially advantageous in that the space occupied on the blister label by arranging safe and secure electrical leads and electrical connection means is minimized and at the same time the number of rupturable zones may be doubled, maintaining the same security for registering the dispensation of a drug dose. In this embodiment, three contacts will be provided, one for each electrical lead. Production wise this is a relatively cheaper embodiment than what is hitherto known in the art, and furthermore the simplicity of transferring dispensing information from the blister label to the device also provides savings in the hardware part of the device in that only a very limited number of contact points must be provided.

In the same manner as mentioned above with reference to the redundancy system, a corresponding system may be provided on the blister label containing three leads in a completely analogue manner.

In yet a further advantageous embodiment each connection extending across each rupturable zone consists of at least two substantially superposed separate secondary electrical leads separated by an insulating layer, and that each lead is connected to two contact islands.

It is rupturable at least in zones corresponding to the blisters, and that for each drug dose there is provided an electrical connection extending across each rupturable zone and that upon rupture the electrical connection will break, and further that each connection extending across each rupturable zone consists of two substantially superposed, separate electrical leads separated by an insulating layer, and that each lead is connected to two contact islands.

The provision of two substantially superposed leads separated by an insulating layer builds up a so-called redundancy system. When the electrical connection is broken the information about the breakage is provided twice to the computing and storage facility in the device. Hereby it is assured that a correct input is gathered Further, should minor divergences in the production of the label occur it is possible to detect these faults by double checking the connectivity of the entire label. Furthermore, as these packages are handled the provision of a two-lead system still assures that the package is usable as it is very unlikely that both electrical leads as well as the insulating layer have been worn out due to handling and dispensing of the packaging blister foil with a blister label.

In a further advantageous embodiment the contact islands on the blister label are arranged along one or more edges of the blister label. In some drug tests where a number, e.g. ten or twenty drug doses are stored on one blister it can be desirable to protect the drug doses. The device can therefore be shaped in such a way that a platform is provided for installing the packaging blister foil with a blister label on such that the drugs are kept protected in the device. In this instance the contact islands can be provided on either side of the card, whereby additional tolerances in placing the contact islands on the blister label can be allowed. However, in other instances it can be desirable to have all contact islands on one edge of the label as this can minimize the size of the device for storing and registering the dispensing of drug doses.

In a further advantageous embodiment the label is partly perforated along the outline of each rupturable zone. By perforating the label material along the outline of each rupturable zone and thereby the outline of each blister it is further assured that by pressing on a blister in an attempt to squeeze out a drug dose this will cause the desired and only the desired blister to deform and to rupture the label causing the corresponding electrical connection to break.

In a further advantageous embodiment each electrical lead/connection corresponds to a unique resistance value. The resistance values are selected such that addition of a random number of resistant values will give unique sums identifying which leads have been broken. This embodiment is especially used in clinical tests where the drug doses have to be taken in a predetermined order. Sometimes it can be desirable to vary the drug dose that a patient is taking or to complement one type of drug with a different type of drug within a certain interval or for other reasons decide a certain sequence of drug taken. By providing on the blister label that each electrical lead/connection corresponds to a unique resistance value the sum of two resistances, i.e. by rupture of two blisters, will indicate exactly which two electrical leads have been broken and by means of the computing means in the device it will be possible to confirm that the correct doses have been taken in the correct order and at the specified time or to generate an error message that a wrong dose has been dispensed.

This arrangement, where each electrical lead/connection corresponds to a unique resistance value makes it possible that all leads share the same contact islands. Although the construction of the blister label with different resistance values corresponding to different electrical leads requires the production to be more precise the device for detecting and computing the data from the blister label can be significantly simplified.

Returning to the method for registering the dispensing of a drug dose, there is basically one method which can utilise the different embodiments of the blister label and the associated advantages of each embodiment of the blister label.

In a first embodiment of the method a method for registering the dispensing of a drug dose, where the dose in tablet, capsule, pill or like form is packaged in packaging blister foil with a blister label, wherein said packaging blister foil with a blister label where said first and second primary electrical leads can be brought into electrical contact with a device, where said device comprises releasable holding means for packaging blister foil with a blister label, contact points for electrical contact with a packaging blister foil with a blister label arranged in the device, a timer device, and a source of energy, and further that a current can be applied via the contact points and the primary leads to the electrical means extending across pocket, and means for registering the resistance in the electrical means and the leads, such that a change in resistance occurring when a drug dose is dispensed and thereby breaks an electrical means is registered and via an analogue to digital converter is transformed to a digital signal, where said signal will be registered, which break will be registered and reset the timer device as well as storing the time, when the electrical lead was broken in a storage means provided in the holding device for later read out or transmission via interface means provided in the holding device as well as computing means arranged to trigger the timer device, compute the input data, and facilitate output.

This method is especially advantageous in connection with using the blister label whereon a system of leads and electrical connection means arranged in parallel are provided.

A second, equally preferred method according to the invention is especially advantageous in connection with use of a blister label where the electrical connection means are in the shape of two substantially superposed site secondary electrical leads. This method for registering the dispensing of a drug dose, where the dose in tablet capsule, pill or the like form is packaged in a packaging blister foil with a blister label, wherein a device, which device comprises holding means for detachably holding a packaging blister foil with a blister label, a timer device, where the holding means comprises electrical contact points and an energy source, such that for each contact island under packaging blister foil with a blister label there is a corresponding contact point in the holding means, such that when the packaging blister foil with a blister label is correctly placed in the holding means an electrical circuit is established, and further such that when a drug dose is dispensed from the packaging blister foil with a blister label by pressing on a blister, such that the drug dose is forced through the rupturable blister label, the corresponding electrical lead for that blister pocket will be broken, which break will be registered and reset the timer device as well as storing the time, when the electrical lead was broken in a storage means provided in the holding device for later read out or transmission via interface means provided in the holding device as well as computing means arranged to trigger the timer device, compute the input data, and facilitate output.

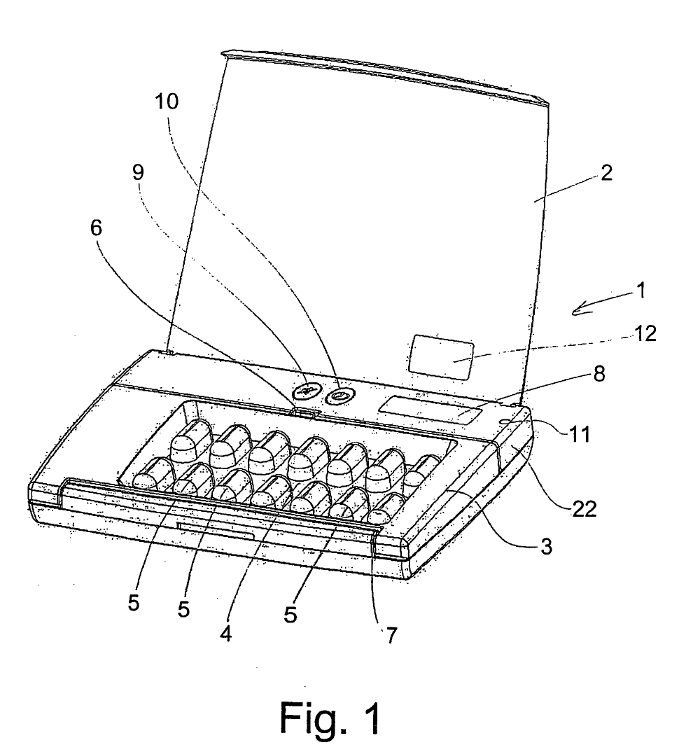

FIG. 1 illustrates a device according to the invention

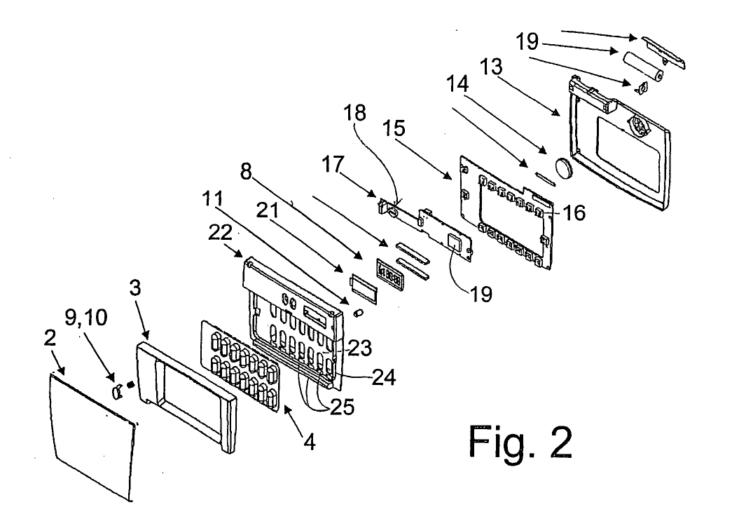

FIG. 2 illustrates an exploded view of a device according to the invention,

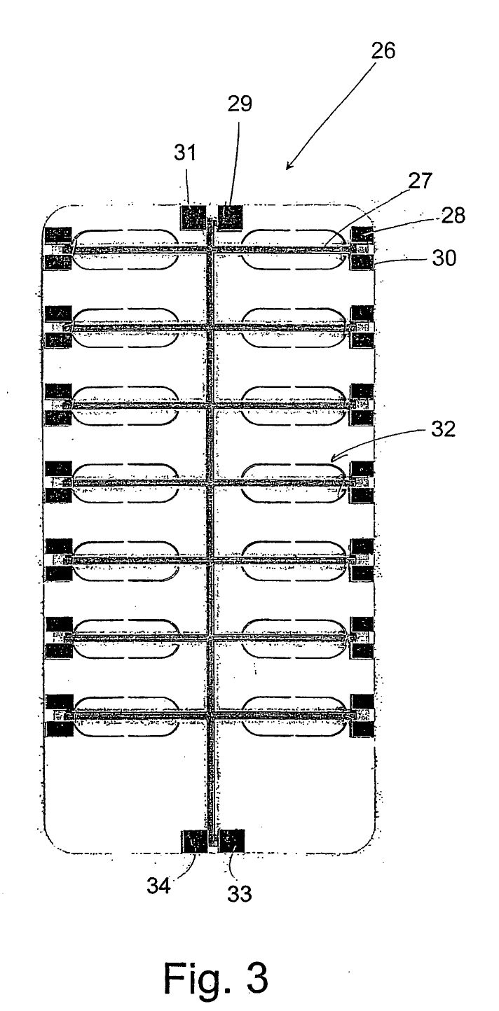

FIG. 3 illustrates a blister label according to the invention,

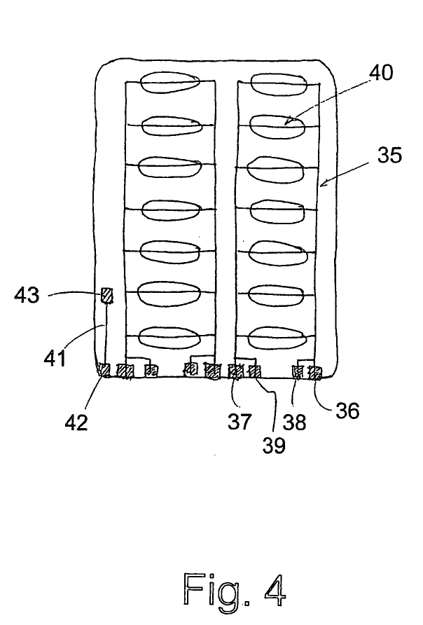

FIG. 4 illustrates an alternative blister label configuration,

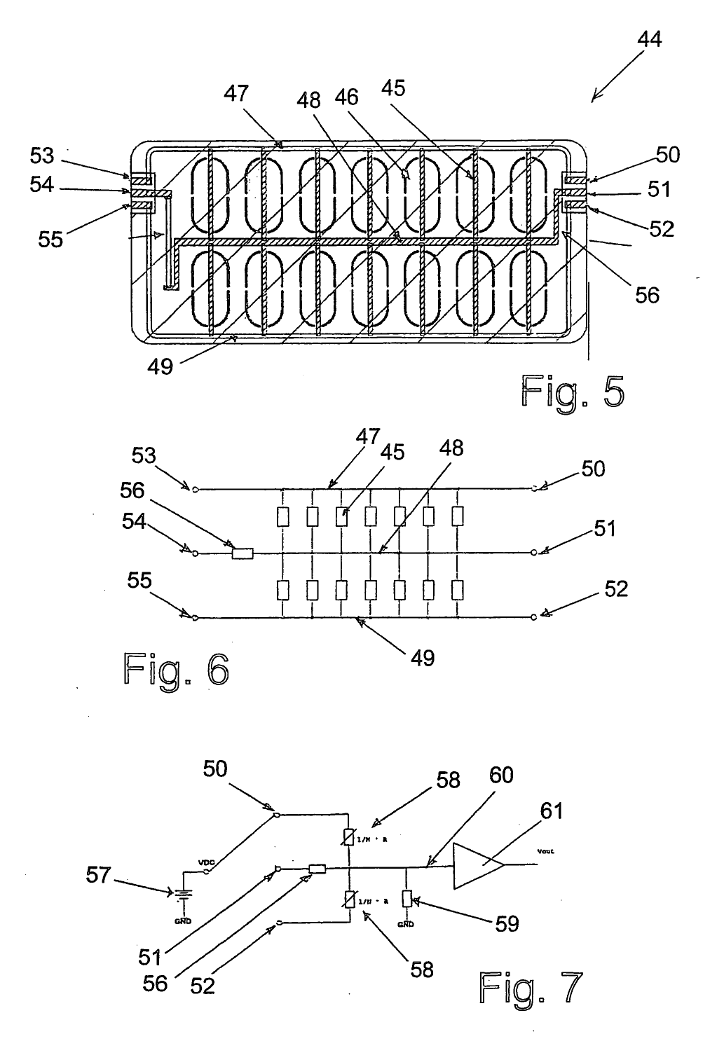

FIG. 5 illustrates an alternative blister label,

FIG. 6 illustrates a schematic diagram of the electric circuitry, and

FIG. 7 illustrates an electronic diagram of blister label/device.

A device 1 for storing and registering the dispensing of drug doses is shown. The device is built up by two pivotable lids 2,3. In the device 1 is inserted a blister for containing in this example fourteen drug doses 5 in tablet form. In FIG. 1 the device 1 is shown in its activated state.

For removing the blister 4 the lid 3 constituting the holding means for the blister must be released by a locking mechanism 6, whereby it is possible to pivot the lid 3 around the hinge 7. The blister 4 can hereafter be removed from the device 1 and a new or different inserted.

On the device is furthermore provided a LED display 8, wherein indications for time elapsed since last drug dispensing, real time, error messages, energy level, and the like can be indicated. The device 1 is furthermore equipped with two buttons 9, 10 for manipulating and controlling the hard/software contained in the device 1. The switch means 9 is used to terminate the audible alarm and the switch 10 is used for setting or resetting of the timing device. Furthermore, a light diode 11 is provided which can be activated when it is time to dispense the next drug dose.

In order to preserve energy a switch (not shown) can be installed, which switch is activated when the lid 2 is pivoted into its open position as indicated in FIG. 1. When this switch is activated an electrical current is induced throughout the device 1 and across the electrical leads in the blister 4.

In order for the user to be able to easily check when the next drug dose is due an aperture can be provided in the pivotable lid 2, whereby it is possible to read the time indication in the display 8 without having to open the device 1 and thereby activating the energy consumption by inducing current in the electrical circuits.

In FIG. 2 is illustrated an exploded view of the device 1. The same elements have the same reference numbers.

On a bottom frame 13 is an audible alarm in the shape of a small loudspeaker 14 arranged the proper circuitry for generating the alarm is provided on the back side of the plate member 15, which also carries contact points 16, which will engage contact islands on the surface of the blister label as will be discussed below.

A print board 17 is provided, which print board carries the necessary electronic circuitry for registering input signals via the contact points 16, computing means 19 for computing intervals at which the drug dose has to be dispensed, an electronic timer device, and a separate energy source 18 for providing energy to the storage facility as well as the timer device. A LED display 8 is provided in order to give the user a possibility to detect the status of the system. Via the display it is possible to get a read out of energy levels in the battery 19 arranged in the basic frame 30, emergency or error messages generated in the computing means 19, real time as well as time from last drug dose dispensed. For design reasons a coloured protective cover 21 can be inserted between the front of the display and the top frame 22 of the device.

In this embodiment the top frame comprises a surface 23 in which a number of apertures 24 are provided. The apertures 24 correspond to the outline of the blisters 5, in which the drug doses are packaged. Furthermore, apertures 25 are provided through which the contact points 16 can come into contact with the contact islands provided on the blister label.

Turning now to FIG. 3 a blister label is illustrated. A packaging blister foil with a blister label of the type which is used in a device as described above is built up from a first foil in which a number of blisters, i.e. depressions, in the foil material has been formed. Each blister 5 has a size and shape which will accommodate one or more drug doses. Usually one single drug dose is packed in each blister. Once the drug doses have been placed in appropriate blisters in the first foil a blister label 26 as illustrated in FIG. 3 is applied, whereby the drug doses are packaged in closed, separate blisters.

An electrical connection 27 extending across each separate blister is provided. The connector comprises two superposed layers of electrically conductive material, which are separated by an insulating layer. Each connection 27 is furthermore connected to two contact islands 28,29.

When a drug dose is dispensed the user will usually press on the first foil constituting a blister 5, whereby a drug dose is squeezed out through the blister label. When the drug dose has to pass the blister label 26 it will break the lead 27.

In order for the user to gain access to the drug doses packed in the blisters it is necessary to open the lid 2, whereby the electrical circuitry will be activated as explained above. The system will detect the breakage of the electrical lead 27 and thereby register that a drug dose has been dispensed. Data of the dispensing will be stored in the data storage as well as a timing device will be activated, whereby the user via the display 8 will be able to check time elapse since last drug dose was dispensed.

In order to further secure that a safe breakage of the superposed two electrical leads 27 is attained the blister label 26 is perforated. The perforation substantially conforms to the shape and size of the drug dose and thereby to the blister in the top foil. For squeezing a drug dose through the blister label the perforation will provide a weak zone where breakage of the material will occur. As the electrical lead 27 extends fully across the blister it is assured that the pressure of a drug dose will cause the electrical connection 27 to break. It is thereby assured that a breakage of the lead 27 will occur and that this will be registered by the circuitry.

By having the double lead construction a redundant system is provided. The advantages of having a redundant system can be seen in the fact that tolerances in the production of the electrical leads, tear and wear during manufacture, transport and installation of the blister in the device as well as control functions in the system itself, all gain from this system.

The computing means 19 will after a blister has been inserted into the device and secured by closing the holding means 3 carry out a control check in order to make sure that the packaging blister foil with a blister label has been correctly inserted into the device. One possibility for checking this is for the circuitry to make sure that the contact islands are superposed appropriate contact points. Alternatively, the contact islands 29,31 and 33,34 can be asymmetrically disposed on the label 26, whereby the system will detect whether or not these have been correctly placed in relation to the contact points built into the device.

The label itself is usually made from a flexible plastic material, paper, cardboard, or mixtures of these materials having similar characteristics, i.e. the possibility to adhere to the blister foil as well as being able to support the drug doses inside the blisters, but being weak enough to break when a user is urging a drug dose out of the blister packaging.

The configuration of the electrical leads and the contact islands on the blister label can be as indicated in FIG. 3. In this configuration all contact islands on the blister label are connected to the circuitry, whereby it is possible to register the breakage of one electrical connection, when a drug dose is taken out of the blister, since the circuitry will detect that an electrical lead has been broken.

In another embodiment of the invention, where the configuration of the electrical lead and the contact islands on the blister label is different this can facilitate the registration of the dispensing of a dose in a different way. In FIG. 4 is illustrated a different configuration where substantially fewer contact islands and therefore substantially fewer contact points are needed in the device. It is therefore cheaper to manufacture the device as well as the blister label.

In FIG. 4 the electrical leads 35 are arranged such that they will extend across the zone on the blister label, where the blisters are placed in parallel. Contact islands 36 are connected via the electrical connections 35 to contact island 37. The second lead layer of the two superposed layers are connected via contact island 38 to 39. The electrical leads as well as the contact islands are preferably made from a material having a substantially content of carbon. When a drug is forced through the blister label and thereby breaks the electrical lead, e.g. the lead indicated by 40, the circuitry will register a relative change in the resistance between contact points 36 and 37, respectively 38,39. By comparing this resistance change in the two superposed lead layers it can be determined that a drug dose has been dispensed.

As a further safeguard to ensure that the registered change is a true value and not due to changes in temperature, moisture, or mechanical wear, a control strip of electrical lead 41 with separate contact islands 42, 43 may be arranged on the blister label. By having a section of reference lead 41 it is possible to correlate the resistance in this control lead with the resistance in the lead extending across the drug doses. Hereby it is possible to clean the result from variations and temperature, moisture, etc.

The connections extending across each blister can furthermore have unique electrical resistance values whereby it becomes possible to detect precisely which drug dose (blister broken) has been dispensed. This is especially important in treatments requiring a certain sequence of drug doses to be taken.

In FIG. 5 is illustrated a blister label 44 according to a preferred embodiment of the invention.

On the label 44 is printed electrical connection means 45 across each rupturable zone 46. The electrical connection means 45 is connected to the first and second leads 47, 48 in both ends of the electrical connection means. In the illustrated embodiment a third lead 49 is also provided, but in principle a label containing only first and second leads having electrical connection means connected between the leads will also achieve the same advantages.

A first set of contact island 50,51,52 is provided adjacent an edge of the blister label 44. By applying a current to the contact islands 50,51 a first resistance value will be measured corresponding to the aggregated resistance value of the leads and the electrical connection means 45 on the upper half of the blister label as indicated in FIG. 5. If a drug dose is dispensed, whereby the rupturable zone 46 breaks the electrical connection means 45, the measured aggregated resistance value measured between the contact islands 50 and 51 will change, indicating that a drug has been dispensed.

A second set of contact island 53,54,55 may be provided adjacent a second edge of the blister label 44. This second set of contact islands provides the blister label with a redundant system such that the advantages of providing a redundancy system on a blister label will be provided for.

Turning to FIG. 6 the electrical circuitry is illustrated in schematic form. The electrical connection means 45 and the associated resistance is illustrated by the rectangular boxes.

In FIG. 7 is illustrated how the blister label in schematic, electronic diagram form is situated in the device for registering when a dose is dispensed. A power source 57 induces a current via contact island 50 to the aggregated resistance illustrated by the signature and reference number 58 corresponding to the aggregated resistance of the resistance value between a first lead and a second lead. A shunt resister 59 is provided such that an analogue signal will be provided for the input 60 to the converter 61. The converter 61 converts the analogue signal provided at 60 into a digital signal for further processing. The further processing part, i.e. the activation of the timer and the registration of time, dose, etc. as mentioned above, is not illustrated in this diagram.

1. Packaging blister foil with a blister label for use in packaging of drugs, for example in tablet, capsule or pill form, where each drug dose is packaged in separate blisters provided in the packaging blister foil and closed off by the blister label, and that said label is rupturable, at least in zones corresponding to the blisters, and that for each drug dose there is provided an electrical connection means having a certain resistance value where said means is extending across each rupturable zone such that when the label is ruptured the electrical connection means will break, wherein each electrical connection means is connected in either end to a first and second lead in parallel electrical connection, and that at least two contact islands are provided at terminal ends of the first and second lead, adjacent an edge of the blister label.

2. Packaging blister foil with a blister label of claim 1, further including a second set of contact islands are provided in the opposite end to the first contact islands of said first and second leads, whereby a redundancy measurement may be conducted.

3. Packaging blister foil with a blister label of claim 1, further including a reference resistor is integral with one of the first or second leads.

4. Packaging blister foil with a blister label of claim 1, further including a second set of electrical connection means corresponding to a second row of drug doses arranged on said blister label is provided, and that said second set of electrical connection means are connected in parallel in a first end of said connection means to the first or second lead and in a second end of said electrical connection means to a third lead, and that said third lead is provided with at least a contact island adjacent the contact islands of the first and second leads, adjacent an edge of the blister label.

5. Packaging blister foil with a blister label of claim 1, further providing each connection extending across each rupturable zone consists of at least two substantially superposed separate secondary electrical leads separated by an insulating layer, and that each lead is connected to two contact islands.

6. Packaging blister foil with a blister label of claim 5, further providing that the contact islands are arranged along one or more edges of the blister label.

7. Packaging blister foil with a blister label of claim 1,
wherein the label is partly perforated along the outline of each rupturable zone.

8. Packaging blister foil with a blister label of claim 5, wherein each secondary electrical lead/connection means corresponds to a unique resistance value.

9. Packaging blister foil with a blister label of claim 1, wherein all leads share the same contact islands.

10. Packaging blister foil with a blister label of claim 5, wherein the primary and/or secondary electrical leads and/or electrical connection means are made of a conductive material with a substantial content of for example carbon and that a reference lead is provided outside a rupturable zone made of the same conductive material.

11. Packaging blister foil with a blister label of claim 1,
further providing that at least two contact islands are arranged asymmetrically on the label.

12. Packaging blister foil with a blister label of claim 1,
wherein data relating to any one or more of the following: drug user, drug type, drug identification, drug manufacturer, sequence of dispensing each dose, prescribing doctor or hospital may be stored on the label.

13. Method for registering the dispensing of a drug dose, where the dose in tablet, capsule, pill or like form is packaged in a packaging blister foil with a blister label of claim 1,
wherein said packaging blister foil with a blister label where said first and second primary electrical leads can be brought into electrical contact with a device, where said device comprises releasable holding means for the packaging blister foil with a blister label, contact points for electrical contact with a packaging blister foil with a blister label arranged in the device, a timer device, and a source of energy, and further that a current can be applied via the contact points and the primary leads to the electrical means extending across pocket, and means for registering the resistance in the electrical means and the leads, such that a change in resistance occurring when a drug dose is dispensed and thereby breaks an electrical means is registered and via an analogue to digital converter is transformed to a digital signal, where said signal will be registered, which break will be registered and reset the timer device as well as storing the time, when the electrical lead was broken in a storage means provided in the holding device for later read out or transmission via interface means provided in the holding device as well as computing means arranged to trigger the timer device, compute the input data, and facilitate output.

14. Method for registering the dispensing of a drug dose, where the dose in tablet capsule, pill or the like form is packaged in a packaging blister foil with a blister label according to claim 1, wherein a device, which device comprises holding means for detachably holding a packaging blister foil with a blister label, a timer device, where the holding means comprises electrical contact points and an energy source, such that for each contact island under the packaging blister foil with a blister label there is a corresponding contact point in the holding means, such that when the packaging blister foil with a blister label is correctly placed in the holding means an electrical circuit is established, and further such that when a drug dose is dispensed from the packaging blister foil with a blister label by pressing on a blister, such that the drug dose is forced through the rupturable blister label, the corresponding electrical lead for that blister pocket will be broken, which break will be registered and reset the timer device as well as storing the time, when the electrical lead was broken in a storage means provided in the holding device for later read out or transmission via interface means provided in the holding device as well as computing means arranged to trigger the timer device, compute the input data, and facilitate output.

15. Device for storing and registering the dispensing of drug doses, where drug doses being packaged in a packaging blister foil with a blister label as defined in claim 1, wherein the device comprises contact points, at least corresponding to contact islands provided on the label as well as holding means for holding said contact islands of the packaging blister foil with a blister label in electrical contact with the contact points, and that said contact points are connected to a computing means comprising an electrical timer system, output means in the form of a display and optionally an audible alarm, data storing means and a source of energy.

16. The device of claim 15, wherein the holding means comprises a first lockable member, which member can be brought from an open position in which a packaging blister foil with a blister label can be placed in the device to a closed position, where the member fixate the packaging blister foil with a blister label in relation to the device, and in particular in relation to the contact points, and optionally control switch means registering if the member is correctly engaged in its closed position.

17. The device of claim 15,
further including means for inducing a current via the contact islands of a blister label and thereby across the electrical connection means, and that said means further comprises a shunt resistor, and optionally a signal amplifier and an analogue/digital converter, such that the output for further processing is digital.

18. The device of claim 15, wherein the computing means generate output to the display indicating in the display simultaneously or by manipulating switches provided on the device, time elapsed from the last drug dispensed, real time, error messages, low energy level, and further optionally a visual and/or audible indicator/alarm.

19. The device of claim 15, further including an interface means in the shape of a mobile flash card device, USB gate, infrared transmission means or a parallel or serial port means for communicating/transferring data to and from an outside device is provided.

20. The device of claim 19,
wherein the computing means can be reprogrammed via the interface means.

21. The device of claim 15,
wherein the computing means comprises data relating to any one or a combination of the following: drug user, drug type, drug identification, drug manufacturer, sequence of dispensing each dose, prescribing doctor or hospital.
